(19) United States
(12) Patent Application Publication
(10) Pub. No.: US 2011/0198530 A1
(43) Pub. Date: Aug. 18, 2011

(54) Method of Producing a Bismuth Vanadium Oxide Derivative of Bi4V2O11 Using Molten Salt Synthesis, and Product Produced

(75) Inventor: Banasri Roy, Socorro, NM (US)

(73) Assignee: New Mexico Technical Foundation, Socorro, NM (US)

(21) Appl. No.: 13/029,013

(22) Filed: Feb. 16, 2011

Related U.S. Application Data
(60) Provisional application No. 61/305,883, filed on Feb. 18, 2010.

(51) Int. Cl. H01G 9/022; H01M 8/10

(52) U.S. Cl. 252/62.2

(57) ABSTRACT

A method comprising mixing a bismuth precursor, a vanadium precursor, and at least one metal dopant precursor together with a salt or salt mixture having a eutectic melting temperature of no greater than 680° C. to form a homogeneous mixture, which is heated to a temperature of from 550° C. to 700° C. to produce a molten state of the salt or salt mixture and to obtain a metal doped bismuth vanadium oxide product that is a derivative of Bi₄V₂O₁₁, which is then cooled. The thus-produced metal doped bismuth vanadium oxide product is present in loose platelet form, with the platelets capable of being aligned such that their planes are substantially parallel to one another.

The instant application should be granted the priority date of Feb. 18, 2010, the filing date of the corresponding provisional application Ser. No. 61/305,883.

### BACKGROUND OF THE INVENTION

The present invention relates to a method of producing a metal doped bismuth vanadium oxide product that is a derivative of Bi₄V₂O₁₁ as well as to the product that is produced.

The high aspect ratio platelets produced by the method of the present application are solid oxide electrolyte systems for use in different industrial applications such as electrolytes that conduct by means of O²⁻ ions, in solid oxide fuel cells, water electrolyzers, oxygen sensors, cathodes and rechargeable batteries, high transition temperature ferroelectrics, catalysts, gas separation membranes, and high temperature heating elements, by way of example only.

It is an object of the present invention to provide an improved method of making a solid electrolyte material textured according to its anisotropic nature, as well as improved high aspect ratio textured γ-BIMEVOX (bismuth metal vanadium oxide) platelet particles.

### BRIEF DESCRIPTION OF THE DRAWINGS

This and other objects and advantages of the present application will be described in detail in the following specification in conjunction with the accompanying schematic drawings, in which:

FIG. 1 is a flow chart showing the molten salt synthesis method of the present application to produce a metal doped bismuth vanadium oxide product;

FIG. 2 shows five scanning electron microscope images showing the development of the platelet morphology of five BICOVOX (bismuth cobalt vanadium oxide) powders;

FIG. 3 shows the x-ray diffraction patterns of the five BICOVOX powders of FIG. 2;

FIG. 4 illustrates the platelet sizes and aspect ratio distributions for the samples (b) and (d) of FIG. 2;

FIG. 5 is a scanning electron microscope image showing the development of the platelet morphology BIMNVOX (bismuth manganese vanadium oxide) based powder of Example 2, Sample 2C, Table 2, and

FIG. 6 is a scanning electron microscope image of the undoped BIVOX (bismuth vanadium oxide) powder of Example 4, Sample 4H, Table 4.

### SUMMARY OF THE INVENTION

The method of the present application comprises the steps of providing a bismuth precursor, providing a vanadium precursor, providing at least one metal dopant precursor, mixing the bismuth precursor, the vanadium precursor and the at least one metal dopant precursor together with a salt or a salt mixture that has a eutectic melting temperature of no greater than 680° C. to form a homogeneous mixture, heating the mixture to a temperature of from 550° C. to 700° C. to produce a molten state of the salt or salt mixture and to obtain a metal doped bismuth vanadium oxide product that is a derivative of Bi₄V₂O₁₁, and cooling the doped bismuth vanadium oxide product.

The method of the present application makes use for the first time of molten salt synthesis to produce a metal doped bismuth vanadium oxide product. Molten salt synthesis (MSS) is a method in which a salt or salt mixture in a molten state is used as a highly reactive medium. In such a process, intimate mixing of the particles involved and enhanced (liquid state) diffusion occurs, which can accelerate the formation of the product phase and its structure.

The metal doped bismuth vanadium oxide product of the present application, which is a derivative of Bi₄V₂O₁₁ and is produced by the molten salt synthesis method of the present application, is present in loose platelet form; these platelets are capable of being aligned with one another such that the planes of the platelets are substantially parallel to one another.

The metal doped bismuth vanadium oxide product produced by the molten salt synthesis method of the present application is a derivative of Bi₄V₂O₁₁ in which at least one of the elements of bismuth and vanadium is partially replaced by, or substituted for, by the metal element or elements of the metal dopant precursor in such a way that the structural type and total charge balance of the gamma phase Bi₄V₂O₁₁ remain intact. Exemplary compositions of the product of the present application can be explained by the following 3 formulas:

(Bi₂₋ₓMₓO₂)(V_{1-y}M′_{y}O_{z})

where M represents one or more dopant metals substituting for, or replacing some of, the starting Bi and having an oxidation number less than or equal to 3; M′ represents one or more dopant metals substituting for, replacing some of, the starting V and having an oxidation number less than, equal to or greater than 5; and the values of x, y and z are the functions of the nature of the substituting elements M and M′. Here, both Bi and V undergo partial substitution;

(Bi₂O₂)(V_{1-y}M′_{y}O₂)

where M′ is as explained above, and y is greater than zero.

Here, only V undergoes partial substitution; and

(Bi₂₋ₓMₓO₂)(VO₂)

where M is as defined above, and x is greater than zero. Here, only Bi undergoes partial substitution.

Also conceivable are derivatives of the first formula where O is partially substituted by F.

Further specific features of the present application will be discussed in detail subsequently.

### DESCRIPTION OF SPECIFIC EMBODIMENTS

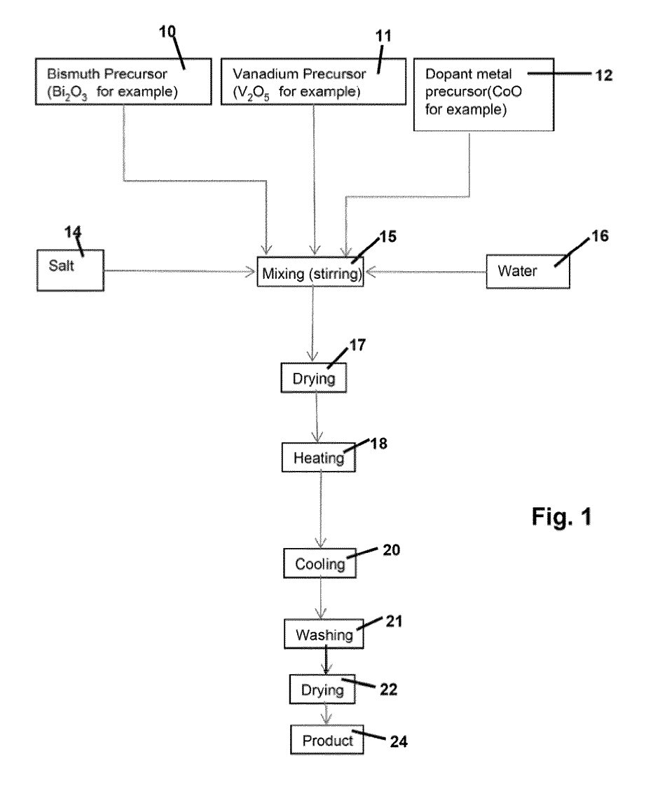

Applicant's method of producing a bismuth vanadium oxide derivative of Bi₄V₂O₁₁ using molten salt synthesis is illustrated by way of example in the flow diagram of FIG. 1, and will now be described in detail.

A bismuth precursor 10, by way of example only Bi₂O₃ in the illustrated embodiment, a vanadium precursor 11, by way of example only V₂O₅ in the illustrated embodiment, and a dopant metal precursor 12, by way of example only the single precursor CoO in the illustrated embodiment, along with a salt or salt mixture, designated generally as “salt” in box 14, are mixed together at box 15 to produce a homogeneous mixture. If the bismuth precursor, vanadium precursor, dopant metal precursor, and the salt or salt mixture are present in solid form, the mixing can be accomplished by grinding, ball milling, stirring, shaking, tumbling or any other suitable method. Another effective way to obtain a homogeneous mixture is by adding the salt or salt mixture in solution form and/or by separately adding water (see box 16) or other suitable fluid, with the mixing together then being accomplished by stirring or any other suitable method. The mixture could even be slightly heated to enhance mixing. In addition, the mixing can take place over an extended period of time. With the addition of the salt or salt mixture as a solution, and/or with water or other liquid, the homogeneous mixture will be present as a solution or as a suspension.

After the homogeneous mixture is achieved, if any water or liquid is present, the slurry will be dried at 17, for example in an oven at, e.g., 100° C., whereupon the dried mass can again be ground into a powder.

To now effect generation of product utilizing molten salt synthesis, the dried powder is heated at 18 to a temperature of from 550° C. to 700° C. The heating can be affected, for example, in a conventional furnace or in a rotary calciner, and at ambient pressure, for example in air, flowing nitrogen or argon, or in any other suitable inert gas. This produces a molten state of the salt or salt mixture. It is, of course, to be understood that the boiling point of the salt or salt mixture must be greater than the pertaining heating temperature in order to be able to maintain the molten state of the salt or salt mixture. The heating or ramping rate can be from a starting rate of 0.5° C./minute up to 50° C./minute to reach the desired temperature, which is then maintained or held for up to 32 hours. The resulting mass is then cooled at 20 and subsequently washed at 21, for example with cold deionized water, by vacuum distillation, decantation, filtering, centrifuging, or the likes, followed by drying at 22, for example at 100° C., whereupon a powder product 24 is collected. This product is a metal doped bismuth vanadium oxide that is a derivative of Bi₄V₂O₁₁. This product of molten salt synthesis is present in loose platelet form, as a consequence of which the platelets are capable of being aligned such that the planes of the platelets are substantially parallel to one another. This makes it possible to maximize the anisotropic nature of material made from applicant's metal doped bismuth vanadium oxide product, thereby maximizing the conductivity thereof, so that such material is especially suitable for the aforementioned applications.

With regard to the salt or salt mixture, it is theoretically possible to use a single salt. However, a combination of two or more salts is preferred since the melting temperature can then be easily controlled within the desired temperature range by controlling the ratio of the salts such that the salt mixture has the desired eutectic melting temperature of no greater than 680° C. Particularly advantageous is the use of both NaCl and KCl, especially in a 1:1 mole ratio. Other possible salts include, but are not limited to, potassium nitrate. The salt or salt mixture advantageously comprises 1 to 50% by weight of the homogeneous mixture. Again, it is to be understood that the boiling point of the salt or salt mixture must be greater than the pertaining heating temperature in order to be able to maintain the molten state of the salt or salt mixture.

In the embodiment illustrated in FIG. 1, Bi₂O₃ was given as an example of a bismuth precursor. However, the bismuth precursor could also be metallic bismuth, other oxides of bismuth, chlorides of Bi, nitrates of Bi, amides of Bi, hydroxides of Bi, sulfates of Bi, sulfides of Bi, oxychlorides of Bi, acetates of Bi, and other organo-bismuth compounds. Furthermore, the particle size of, for example, the oxides of bismuth can be up to 50 microns.

Similarly, although in FIG. 1 V₂O₅ was given as an example of a vanadium precursor, other vanadium precursors could also be used, such as just vanadium, other oxides of vanadium, chlorides of V, nitrates of V, amides of V, hydroxides of V, sulfates of V, sulfides of V, oxychlorides of V, acetates of V and other organo-vanadium compounds. The particle size of, for example, the oxides of vanadium can be up to 75 microns.

With regard to the metal dopant precursor, although in the embodiment of FIG. 1 CoO was given as an example, the dopant metal precursor could also be Zn, Cu, Co, Fe, Mn, Na, Pb, Cd, Ca, Ba, Sr, Sb, In, Al, Ti, Sn, Ru, Nb, Ta, P, rare earth elements, oxides, chlorides, nitrates, amides, hydroxides, sulfates, sulfides, oxychlorides, acetates or other water soluble salts of the preceding, and other organo-metallic compounds. In addition, although a single dopant metal precursor was listed for the embodiment of FIG. 1, it would also be possible to use two or more different metal dopant precursors, as can be seen from the subsequent discussion in conjunction with some of the Examples. Furthermore, the at least one metal dopant precursor is preferably present at 10 to 15 atomic % relative to vanadium and/or 10 to 20 atomic % relative to bismuth.

The following Examples show the effect on applicant's process of a number of different parameters, including the effect of heating time and/or temperature on the development of phase and platelet morphology of metal doped bismuth vanadate powder (the Group 1 Examples); the effect of different Bi, V and doping metal precursors on the development of the platelet morphology of metal doped bismuth vanadate powder (the Group 2 Examples); the effect of the particle sizes of Bi, V, and Co precursors on the development of the gamma phase and platelet morphology of metal doped bismuth vanadate powder (the Group 3 Examples); the effect of the amount of doping metal on the development of the gamma phase and platelet morphology of metal doped bismuth vanadate powder (the Group 4 Examples); the effect of different types and different compositions (wt %) of salt or salt mixture on the development to the gamma phase and platelet morphology of metal doped bismuth vanadate powder (the Group 5 Examples); the effect of different heating and cooling rates on the development of the gamma phase and platelet morphology of metal doped bismuth vanadate powder (the Group 6 Examples); and the effect of different pressures on the development of the gamma phase and platelet morphology of metal doped bismuth vanadate powder (the Group 7 Examples).

### Example 1

4.66 gm of bismuth oxide (Bi₂O₃, Aldrich), 0.72752 gm of vanadium oxide (V₂O₅, Aldrich), and 0.14986 gm of cobalt oxide (CoO, Cerac Inc.) were ball milled together with an equal weight (100% with total precursor weight; 5.54 gm) of salt in 250 cc deionized (DI) water for 24 h. The salt was a 1:1 mole ratio of NaCl (Aldrich) and KCl (Aldrich) representing the eutectic composition. The mixed slurry was dried at 100° C. in an oven. The dried mass was lightly ground into powder with mortar and pestle.

### Sample 1A

Part of the dried powder was placed in a closed alumina crucible and heated in air from room temperature to 550° C. Heating rate was 10° C. per minute and held at 550° C. for 30 min. After furnace cooling, the fused mass was repeatedly washed with cold DI water. The mass was dried at 100° C. and collected as powder. X-ray powder diffraction showed this powder to be mostly randomly oriented mixed phase of Bi₂O₃+V₂O₅+CoO+β-BICOVOX+α-BICOVOX+BiVO₄. A scanning electron micrograph of this sample showed equiaxed 3-d particles.

### Sample 1B

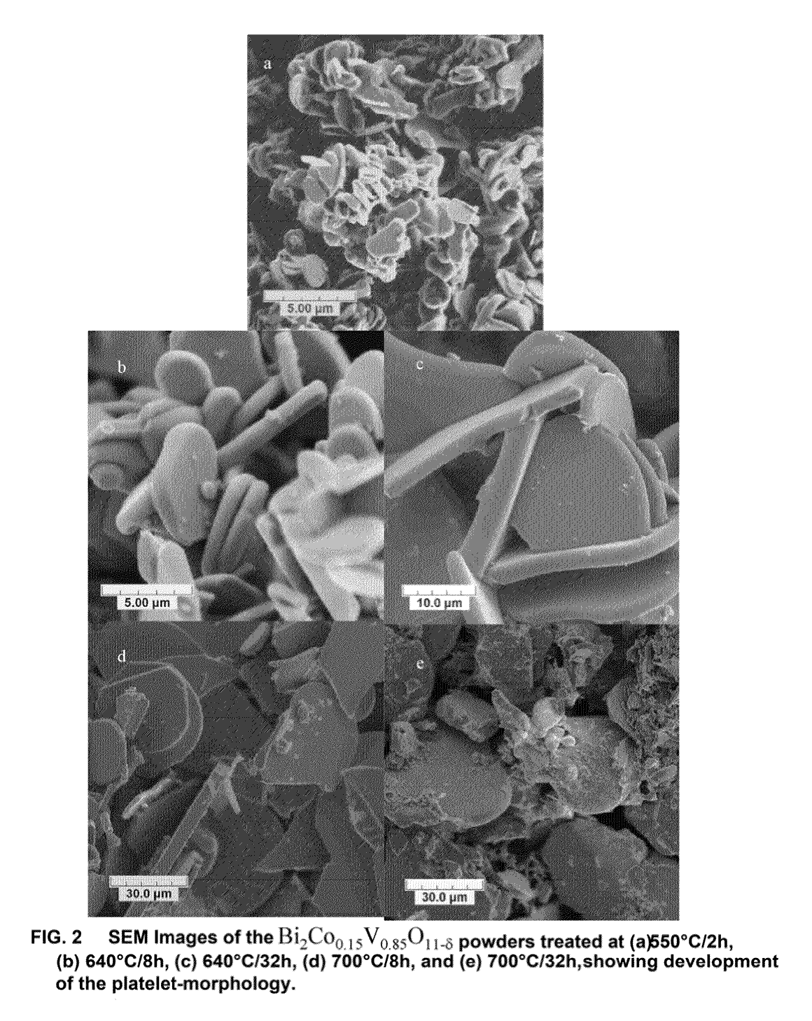

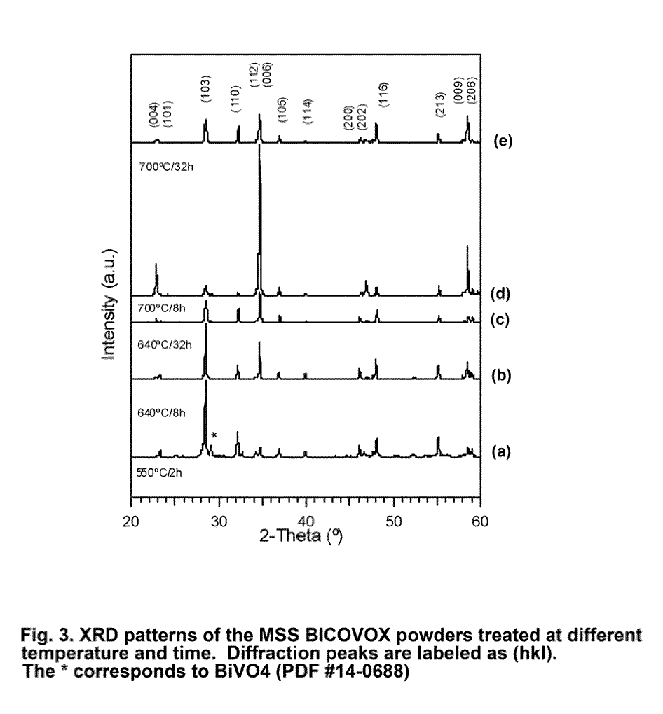

Part of the dried powder was placed in a closed alumina crucible and heated in air from room temperature to 550° C. Heating rate was 10° C. per minute and held at 550° C. for 2 h. After furnace cooling, the fused mass was repeatedly washed with cold DI water. The mass was dried at 100° C. and collected as powder. X-ray powder diffraction showed this powder to be mostly pure γ-BICOVOX (FIG. 3 at “a”) with small amount of BiVO₄ indicated by * (PDF #14-0688). A scanning electron micrograph of this sample (FIG. 2a) shows particles of platelet morphology with a size of 0.5 to 5 micron along major axis, thickness 0.1 to 1 micron and aspect ratio of 1 to 10.

### Sample 1C

Part of the dried powder was placed in a closed alumina crucible and heated in air from room temperature to 550° C. Heating rate was 10° C. per minute and held at 640° C. for 15 min. After furnace cooling, the fused mass was repeatedly washed with cold DI water. The mass was dried at 100° C. and collected as powder. X-ray powder diffraction showed this powder to be mostly randomly oriented mixed phase of Bi₂O₃+V₂O₅+CoO+β-BICOVOX+α-BICOVOX+BiVO₄. A scanning electron micrograph of this sample showed equiaxed 3-d particles.

### Sample 10

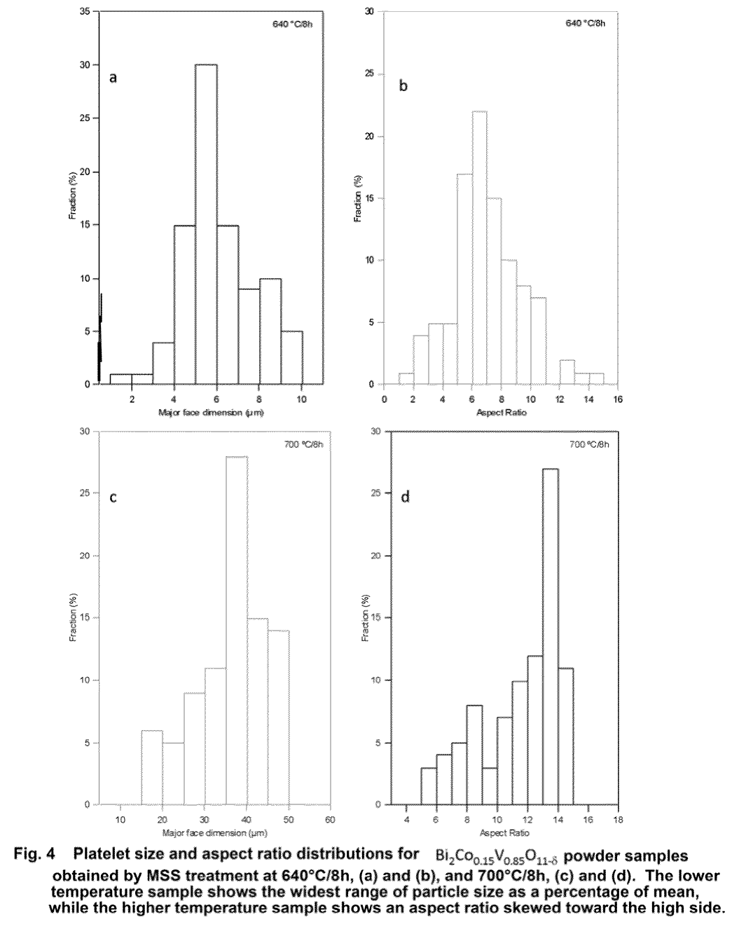

Part of this dried powder was placed in a closed alumina crucible and heated in air from room temperature to 640° C. Heating rate was 10° C. per minute and held at 640° C. for 8 h. After furnace cooling, the fused mass was repeatedly washed with cold DI water. The mass was dried at 100° C. and collected as powder. X-ray powder diffraction showed this powder to be pure γ-BICOVOX (FIG. 3 at “b”). A scanning electron micrograph of this sample (FIG. 2b) shows particles of platelet morphology with an average size of 1 to 10 micron along major axis, thickness 0.5 to 1 micron and aspect ratio of 1 to 10. See also FIG. 4.

### Sample 1E

Another part of this dried powder was placed in a closed alumina crucible and heated in air from room temperature to 640° C. Heating rate was 10° C. per minute and held at 640° C. for 32 h. After furnace cooling, the fused mass was repeatedly washed with cold DI water. The mass was dried at 100° C. and collected as powder. X-ray powder diffraction showed this powder to be pure γ-BICOVOX (FIG. 3 at “c”). A scanning electron micrograph of this sample (FIG. 2c) shows particles of platelet morphology with an average size of major axis 5 to 25 micron, thickness 1 to 6 micron and aspect ratio of 2 to 12.

### Sample 1F

Part of this dried powder was placed in a closed alumina crucible and heated in air from room temperature to 550° C. Heating rate was 10° C. per minute and held at 700° C. for 15 min. After furnace cooling, the fused mass was repeatedly washed with cold DI water. The mass was dried at 100° C. and collected as powder. X-ray powder diffraction showed this powder to be mostly randomly oriented mixed phase (Bi₂O₃+V₂O₅+CoO+β-BICOVOX+α-BICOVOX+BiVO₄). A scanning electron micrograph of this sample showed equiaxed 3-d particles.

### Sample 1G

Another part of this dried powder was placed in a closed alumina crucible and heated in air from room temperature to 700° C. Heating rate was 10° C. per minute and held at 700° C. for 8 h. After furnace cooling, the fused mass was repeatedly washed with cold DI water. The mass was dried at 100° C. and collected as powder. X-ray powder diffraction showed this powder to be pure γ-BICOVOX (FIG. 3 at “d”) with strong (00I) orientation. A scanning electron micrograph of this sample (FIG. 2d) shows particles of platelet morphology with an average size of 20 to 50 micron along major axis, thickness 1 to 10 micron and aspect ratio of 5 to 15. See also FIG. 4

### Sample 1H

Another part of this dried powder was placed in a closed alumina crucible and heated in air from room temperature to 700° C. Heating rate was 10° C. per minute and held at 700° C. for 32 h. After furnace cooling, the fused mass was repeatedly washed with cold DI water. The mass was dried at 100° C. and collected as powder. X-ray powder diffraction showed this powder to be pure γ-BICOVOX (FIG. 3 at “e”) with diminished (00I) peaks. A scanning electron micrograph of this sample (FIG. 2e) revealed the crushed and broken morphology of the platelet particles. This result shows effect of heating temperature and holding time on the morphology of metal doped bismuth vanadate powder.

Table 1 summarizes the results.

TABLE 1
Effect of Heating Temperature and Holding Time

| | Temp | holding | Product | |
|---|---|---|---|---|
| Sample | (° C.) | time | Phase | Morphology |
| 1A | 550 | 30 min | Bi₂O₃ + V₂O₅ + CoO + β- | Random equiaxed 3-d particles |
| | | | BICOVOX + α- | |
| | | | BICOVOX + BiVO₄ | |
| 1B | 550 | 2 h | γ-BICOVOX + small | Platelets of small aspect ratio |
| | | | BiVO₄ | |
| 1C | 640 | 15 min | Bi₂O₃ + V₂O₅ + CoO + γ- | Mostly Random equiaxed 3-d |
| | | | BICOVOX + β- | particles + few platelets |
| | | | BICOVOX + α- | |
| | | | BICOVOX + BiVO₄ | |
| 1D | 640 | 8 h | γ-BICOVOX | Well developed platelets of aspect |
| | | | | ratio 1-10 |
| 1E | 640 | 32 h | γ-BICOVOX | Well developed platelets of 5-25 |
| | | | | micron & aspect ratio 1-10 |
| 1F | 700 | 15 min | Bi₂O₃ + V₂O₅ + CoO + γ- | Mostly Random equiaxed 3-d |
| | | | BICOVOX + β- | particles + few platelets |
| | | | BICOVOX + α- | |
| | | | BICOVOX + BiVO₄ | |
| 1G | 700 | 8 h | γ-BICOVOX | Well developed platelets of 20-50 |
| | | | | micron & aspect ratio 5-15 |
| 1H | 700 | 32 h | γ-BICOVOX | Well developed platelets + |
| | | | | broken particles |

### Example 2

### Sample 2A

6.3 gm of bismuth chloride (BiCl₃, Acros Organics), 1.34 gm of vanadium chloride (VCl₃, Acros Organics), and 0.4365 gm of cobalt nitrate hexahydrate (Co(NO₃)₂.6H₂O, Acros Organics) were ball milled together with an equal weight (8.0765 gm) of salt in 250 cc deionized (DI) water for 24 h. The salt was a 1:1 mole ratio of NaCl (Aldrich) and KCl (Aldrich), representing the eutectic composition. The mixed slurry was dried at 100° C. in an oven. The dried mass was lightly ground into powder with mortar and pestle.

### Sample 2B

5.2 gm of bismuth hydroxide (H₃BiO₃, Acros Organics), 1.3855 gm of vanadyl sulphonate (VOSO₄.nH₂O, Acros Organics), and 0.4365 gm of cobalt nitrate hexahydrate (Co(NO₃)₂.6H₂O, Acros Organics) were ball milled together with an equal weight (7.022 gm) of salt in 250 cc deionized (DI) water for 24 h. The salt was a 1:1 mole ratio of NaCl (Aldrich) and KCl (Aldrich), representing the eutectic composition. The mixed slurry was dried at 100° C. in an oven. The dried mass was lightly ground into powder with mortar and pestle.

### Sample 2C

9.7 gm of bismuth nitrate penta hydrate (Bi(NO₃)₃.5H₂O, Acros Organics), 0.637 gm of vanadium trioxide (V₂O₃, Acros Organics), and 0.1305 gm of manganese dioxide (MnO₂, Acros Organics) were ball milled together with an equal weight (10.47 gm) of salt in 250 cc deionized (DI) water for 24 h. The salt was a 1:1 mole ratio of NaCl (Aldrich) and KCl (Aldrich), representing the eutectic composition. The mixed slurry was dried at 100° C. in an oven. The dried mass was lightly ground into powder with mortar and pestle.

### Sample 2D

9.7 gm of bismuth nitrate penta hydrate (Bi(NO₃)₃.5H₂O, Acros Organics), 0.9945 gm of ammonium vanadate (VO₃NH₄, Acros Organics), and 0.189 gm of manganese dichloride (MnCl₂, Acros Organics) were ball milled together with an equal weight (10.88 gm) of salt in 250 cc deionized (DI) water for 24 h. The salt was a 1:1 mole ratio of NaCl (Aldrich) and KCl (Aldrich), representing the eutectic composition. The mixed slurry was dried at 100° C. in an oven. The dried mass was lightly ground into powder with mortar and pestle.

### Sample 2E

9.7 gm of bismuth nitrate penta hydrate (Bi(NO₃)₃.5H₂O, Acros Organics), 1.337 gm of vanadium trichloride (VCl₃, Acros Organics), and 0.1193 gm of cuprous oxide (CuO, Acros Organics) were ball milled together with an equal weight (11.15 gm) of salt in 250 cc deionized (DI) water for 24 h. The salt was a 1:1 mole ratio of NaCl (Aldrich) and KCl (Aldrich), representing the eutectic composition. The mixed slurry was dried at 100° C. in an oven. The dried mass was lightly ground into powder with mortar and pestle.

### Sample 2F

5.2 gm of bismuth oxychloride (BiOCl, Acros Organics), 0.773 gm of vanadium pentoxide (V₂O₅, Acros Organics), and 0.12 gm of ferric oxide (Fe₂O₃, Acros Organics) were ball milled together with an equal weight (6.1) of salt in 250 cc deionized (DI) water for 24 h. The salt was a 1:1 mole ratio of NaCl (Aldrich) and KCl (Aldrich), representing the eutectic composition. The mixed slurry was dried at 100° C. in an oven. The dried mass was lightly ground into powder with mortar and pestle.

### Sample 2G

4.66 gm of bismuth trioxide (Bi₂O₃, Acros Organics), 0.773 gm of vanadium pentoxide (V₂O₅, Acros Organics), and 0.0562 gm of cobalt oxide (CoO, Acros Organics) and 0.065 gm of manganese dioxide MnO₂, Acros Organics) were ball milled together with an equal weight (5.56) of salt in 250 cc deionized (DI) water for 24 h. The salt was a 1:1 mole ratio of NaCl (Aldrich) and KCl (Aldrich), representing the eutectic composition. The mixed slurry was dried at 100° C. in an oven. The dried mass was lightly ground into powder with mortar and pestle.

### Sample 2H

2.33 gm of bismuth trioxide (Bi₂O₃, Acros Organics), 4.85 gm of bismuth nitrate pentahydrate (Bi(NO₃)₂.5H₂O, Acros Organics), 0.773 gm of vanadium pentoxide (V₂O₅, Acros Organics), and 0.0374 gm of cobalt oxide (CoO, Acros Organics), 0.0435 gm of manganese dioxide (MnO₂, Acros Organics), and 0.04 gm of ferric oxide (Fe₂O₃, Acros Organics) were ball milled together with an equal weight (5.56) of salt in 250 cc deionized (DI) water for 24 h. The salt was a 1:1 mole ratio of NaCl (Aldrich) and KCl (Aldrich), representing the eutectic composition. The mixed slurry was dried at 100° C. in an oven. The dried mass was lightly ground into powder with mortar and pestle.

### Sample 21

2.33 gm of bismuth trioxide (Bi₂O₃, Acros Organics), 4.85 gm of bismuth nitrate pentahydrate (Bi(NO₃)₃.5H₂O, Acros organics), 0.3865 gm of vanadium pentoxide (V₂O₅, Acros Organics), 0.693 gm of vanadyl sulphonate (VOSO₄.nH₂O, Acros Organics), 0.0374 gm of cobalt oxide (CoO, Acros Organics), 0.0435 gm of manganese dioxide (MnO₂, Acros Organics), and 0.04 gm of ferric oxide (Fe₂O₃, Acros Organics) were ball milled together with an equal weight (5.56) of salt in 250 cc deionized (DI) water for 24 h. The salt was a 1:1 mole ratio of NaCl (Aldrich) and KCl (Aldrich), representing the eutectic composition. The mixed slurry was dried at 100° C. in an oven. The dried mass was lightly ground into powder with mortar and pestle.

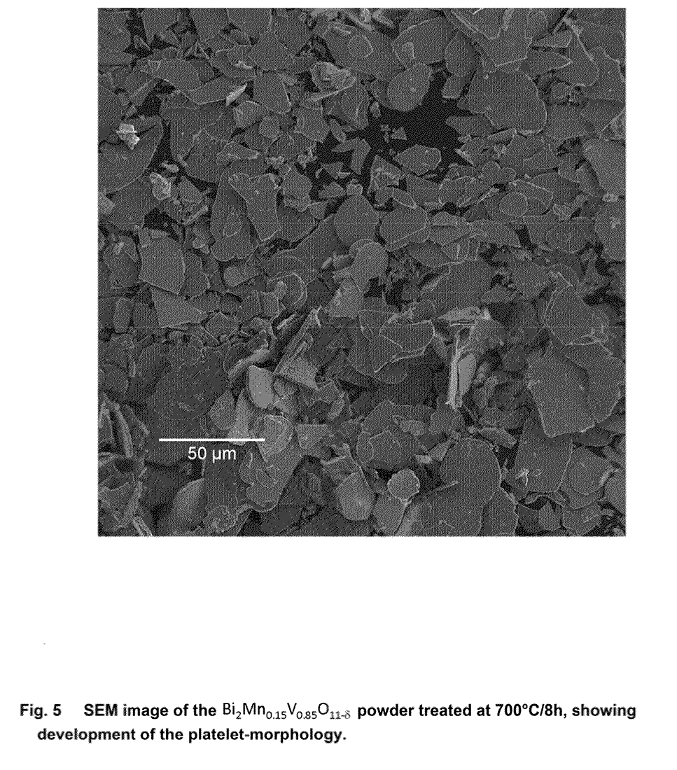

These dried powders were placed in closed alumina crucibles and heated in air from room temperature to 700° C. Heating rate was 10° C. per minute and held at 700° C. for 8 h. After furnace cooling, the fused mass was repeatedly washed with cold DI water. The mass was dried at 100° C. and collected as powder. X-ray powder diffraction and SEM data as summarized in Table 2 showed that all of the samples are phase pure γ-BIMVOX powder with well developed platelets of 20-50 micron along major axis & aspect ratio 5-15. See also FIG. 5, as an example. M stands for the respective dopant metal.

TABLE 2
Effect of different Bi, V and doping metal precursors

| | Precursors | | | Product | |
|---|---|---|---|---|---|
| Sample | Bi | V | Doping metal | Phase | Morphology |
| 2A | BiCl₃ | VCl₃ | Co(NO₃)₂•6H₂O | γ- | Well developed platelets of 20-50 micron in |
| | | | | BICOVOX | major axis & aspect ratio 6-15 |
| 2B | H₃BiO₃ | VOSO₄•nH₂O | Co(NO₃)₂•6H₂O | γ- | Well developed platelets of 20-50 micron in |
| | | | | BICOVOX | major axis & aspect ratio 4-14 |
| 2C | Bi(NO₃)₃•5H₂O | V₂O₃ | MnO₂ | γ- | Well developed platelets of 20-50 micron in |
| | | | | BIMnVOX | major axis & aspect ratio 5-15 |
| 2D | Bi(NO₃)₃•5H₂O | VO₃NH₄ | MnCl₂ | γ- | Well developed platelets of 20-50 micron in |
| | | | | BIMnVOX | major axis & aspect ratio 3-15 |
| 2E | Bi(NO₃)₃•5H₂O | VCl₃ | CuO | γ- | Well developed platelets of 20-50 micron in |
| | | | | BICuVOX | major axis & aspect ratio 4-18 |
| 2F | BiClO | V₂O₅ | Fe₂O₃ | γ- | Well developed platelets of 20-50 micron in |
| | | | | BIFeVOX | major axis & aspect ratio 3-17 |
| 2G | Bi₂O₃ | V₂O₅ | CoO + MnO₂ | γ- | Well developed platelets of 20-50 micron in |
| | | | | BICOMnVOX | major axis & aspect ratio 5-15 |
| 2H | Bi₂O₃ + | V₂O₅ | CoO + MnO₂ + Fe₂O₃ | γ- | Well developed platelets of 20-50 micron in |
| | Bi(NO₃)₃•5H₂O | | | BICOMnFeVOX | major axis & aspect ratio 5-15 |
| 2I | Bi₂O₃ + | V₂O₅ + | CoO + MnO₂ + Fe₂O₃ | γ- | Well developed platelets of 20-50 micron in |
| | Bi(NO₃)₃•5H₂O | VOSO₄•nH₂O | | BICOMnFeVOX | major axis & aspect ratio 5-15 |

### Example 3

### Sample 3A

4.66 gm of bismuth oxide (Bi₂O₃, Aldrich, ≦30 micron particle size), 0.72752 gm of vanadium oxide (V₂O₅, Aldrich, ≦30 micron particle size), and 0.14986 gm of cobalt oxide (CoO, Cerac Inc., ≦30 micron particle size) were ball milled together with an equal weight (5.54 gm) of salt in 250 cc DI water for 24 h. The salt was a 1:1 mole ratio of NaCl (Aldrich) and KCl (Aldrich) representing the eutectic composition. The mixed slurry was dried at 100° C. in an oven. The dried mass was lightly ground into powder with mortar and pestle.

### Sample 3B

4.66 gm of bismuth oxide (Bi₂O₃, Aldrich, ≦30 micron particle size), 0.72752 gm of vanadium oxide (V₂O₅, Aldrich, ≦50 micron particle size), and 0.14986 gm of cobalt oxide (CoO, Cerac Inc., ≦30 micron particle size) were ball milled together with an equal weight (5.54 gm) of salt in 250 cc DI water for 24 h. The salt was a 1:1 mole ratio of NaCl (Aldrich) and KCl (Aldrich) representing the eutectic composition. The mixed slurry was dried at 100° C. in an oven. The dried mass was lightly ground into powder with mortar and pestle.

### Sample 3C

4.66 gm of bismuth oxide (Bi₂O₃, Aldrich, ≦30 micron particle size), 0.72752 gm of vanadium oxide (V₂O₅, Aldrich, ≦50 micron particle size), and 0.14986 gm of cobalt oxide (CoO, Cerac Inc., ≦50 micron particle size) were ball milled together with an equal weight (5.54 gm) of salt in 250 cc DI water for 24 h. The salt was a 1:1 mole ratio of NaCl (Aldrich) and KCl (Aldrich) representing the eutectic composition. The mixed slurry was dried at 100° C. in an oven. The dried mass was lightly ground into powder with mortar and pestle.

### Sample 3D

4.66 gm of bismuth oxide (Bi₂O₃, Aldrich, ≦50 micron particle size), 0.72752 gm of vanadium oxide (V₂O₅, Aldrich, ≦50 micron particle size), and 0.14986 gm of cobalt oxide (CoO, Cerac Inc., micron particle size) were ball milled together with an equal weight (5.54 gm) of salt in 250 cc DI water for 24 h. The salt was a 1:1 mole ratio of NaCl (Aldrich) and KCl (Aldrich) representing the eutectic composition. The mixed slurry was dried at 100° C. in an oven. The dried mass was lightly ground into powder with mortar and pestle.

### Sample 3E

4.66 gm of bismuth oxide (Bi₂O₃, Aldrich, 50-100 micron particle size), 0.72752 gm of vanadium oxide (V₂O₅, Aldrich, 50-100 micron particle size), and 0.14986 gm of cobalt oxide (CoO, Cerac Inc., 50-100 micron particle size) were ball milled together with an equal weight (5.54 gm) of salt in 250 cc DI water for 24 h. The salt was a 1:1 mole ratio of NaCl (Aldrich) and KCl (Aldrich) representing the eutectic composition. The mixed slurry was dried at 100° C. in an oven. The dried mass was lightly ground into powder with mortar and pestle.

### Sample 3F

4.66 gm of bismuth oxide (Bi₂O₃, Aldrich, 50-200 micron particle size), 0.72752 gm of vanadium oxide (V₂O₅, Aldrich, 50-200 micron particle size), and 0.14986 gm of cobalt oxide (CoO, Cerac Inc., 50-200 micron particle size) were ball milled together with an equal weight (5.54 gm) of salt in 250 cc DI water for 24 h. The salt was a 1:1 mole ratio of NaCl (Aldrich) and KCl (Aldrich) representing the eutectic composition. The mixed slurry was dried at 100° C. in an oven. The dried mass was lightly ground into powder with mortar and pestle.

These dried powders were placed in closed alumina crucibles and heated in air from room temperature to 700° C. Heating rate was 10° C. per minute and held at 700° C. for 8 h. After furnace cooling, the fused mass was repeatedly washed with cold DI water. The mass was dried at 100° C. and collected as powder. X-ray powder diffraction and SEM data as summarized in Table 3 showed that the precursors with 50 particle size products (samples 3A-3D) are phase pure γ-BICOVOX powder with well developed platelets of 20-50 micron in major axis & aspect ratio 5-15. The precursors with 50-100 particle size product (sample 3E) is mixed phase (γ-BICOVOX+β-BICOVOX+α-BICOVOX+BiVO₄) with mixed morphology of platelets of 5-15 micron in major axis & aspect ratio 1-15 with random equiaxed particles. The precursors with 50-200 particle size product (sample 3F) is mixed phase (Bi₂O₃+V₂O₅+CoO+γ-BICOVOX+β-BICOVOX+α-BICOVOX+BiVO₄) and mixed morphology.

TABLE 3
Effect of particle sizes of Bi, V, and Co precursors

| | Precursors | | | Product | |
|---|---|---|---|---|---|
| Sample | Bi | V | Doping metal | Phase | Morphology |
| 3A | Bi₂O₃; ≦30 | V₂O₅; ≦30 | CoO; ≦30 | γ-BICOVOX | Well developed platelets of 20-50 |
| | micron | micron | micron | | micron in major axis & aspect ratio |
| | | | | | 5-15 |
| 3B | Bi₂O₃; ≦30 | V₂O₅; ≦50 | CoO; ≦30 | γ-BICOVOX | Well developed platelets of 20-50 |
| | micron | micron | micron | | micron in major axis & aspect ratio |
| | | | | | 5-15 |
| 3C | Bi₂O₃; ≦30 | V₂O₅; ≦50 | CoO; ≦50 | γ-BICOVOX | Well developed platelets of 20-50 |
| | micron | micron | micron | | micron in major axis & aspect ratio |
| | | | | | 5-15 |
| 3D | Bi₂O₃; ≦50 | V₂O₅; ≦50 | CoO; ≦50 | γ-BICOVOX | Well developed platelets of 20-50 |
| | micron | micron | micron | | micron in major axis & aspect ratio |
| | | | | | 5-15 |
| 3E | Bi₂O₃; 50-100 | V₂O₅; 50-100 | CoO; 50-100 | γ-BICOVOX + β- | platelets of 2-10 micron in major axis |
| | micron | micron | micron | BICOVOX + α- | & aspect ratio 1-8 + |
| | | | | BICOVOX + | Random equiaxed particles |
| | | | | BiVO₄ | |
| 3F | Bi₂O₃; 50-200 | V₂O₅; 50-200 | CoO; 50-200 | Bi₂O₃ + V₂O₅ + | Mixed morphology-acicular + |
| | micron | micron | micron | CoO + γ- | random 3 D + platelet particles |
| | | | | BICOVOX + β- | |
| | | | | BICOVOX + α- | |
| | | | | BICOVOX + | |
| | | | | BiVO₄ | |

### Example 4

### Sample 4A

4.66 gm of bismuth oxide (Bi₂O₃, Aldrich), 0.846 gm of vanadium oxide (V₂O₅, Aldrich), and 0.0524 gm of cobalt oxide (CoO, Cerac Inc.) were ball milled together with an equal weight (5.56 gm) of salt in 250 cc deionized (DI) water for 24 h. The salt was a 1:1 mole ratio of NaCl (Aldrich) and KCl (Aldrich) representing the eutectic composition. The mixed slurry was dried at 100° C. in an oven. The dried mass was lightly ground into powder with mortar and pestle.

### Sample 4B

4.66 gm of bismuth oxide (Bi₂O₃, Aldrich), 0.8185 gm of vanadium oxide (V₂O₅, Aldrich), and 0.07493 gm of cobalt oxide (CoO, Cerac Inc.) were ball milled together with an equal weight (5.56 gm) of salt in 250 cc deionized (DI) water for 24 h. The salt was a 1:1 mole ratio of NaCl (Aldrich) and KCl (Aldrich) representing the eutectic composition. The mixed slurry was dried at 100° C. in an oven. The dried mass was lightly ground into powder with mortar and pestle.

### Sample 4C

4.66 gm of bismuth oxide (Bi₂O₃, Aldrich), 0.72752 gm of vanadium oxide (V₂O₅, Aldrich), and 0.15 gm of cobalt oxide (CoO, Cerac Inc.) were ball milled together with an equal weight (5.54 gm) of salt in 250 cc deionized (DI) water for 24 h. The salt was a 1:1 mole ratio of NaCl (Aldrich) and KCl (Aldrich) representing the eutectic composition. The mixed slurry was dried at 100° C. in an oven. The dried mass was lightly ground into powder with mortar and pestle.

### Sample 4D

4.66 gm of bismuth oxide (Bi₂O₃, Aldrich), 0.682 gm of vanadium oxide (V₂O₅, Aldrich), and 0.18725 gm of cobalt oxide (CoO, Cerac Inc.) were ball milled together with an equal weight (5.54 gm) of salt in 250 cc deionized (DI) water for 24 h. The salt was a 1:1 mole ratio of NaCl (Aldrich) and KCl (Aldrich) representing the eutectic composition. The mixed slurry was dried at 100° C. in an oven. The dried mass was lightly ground into powder with mortar and pestle.

### Sample 4E

4.427 gm of bismuth oxide (Bi₂O₃, Aldrich), 0.052 gm of aluminum oxide (Al₂O₃, Acros Organics), 0.773 gm of vanadium oxide (V₂O₅, Aldrich), and 0.1124 gm of cobalt oxide (CoO, Cerac Inc.) were ball milled together with an equal weight (5.36 gm) of salt in 250 cc deionized (DI) water for 24 h. The salt was a 1:1 mole ratio of NaCl (Aldrich) and KCl (Aldrich) representing the eutectic composition. The mixed slurry was dried at 100° C. in an oven. The dried mass was lightly ground into powder with mortar and pestle.

### Sample 4F

4.194 gm of bismuth oxide (Bi₂O₃, Aldrich), 0.102 gm of aluminum oxide (Al₂O₃, Acros Organics), 0.773 gm of vanadium oxide (V₂O₅, Aldrich), and 0.1124 gm of cobalt oxide (CoO, Cerac Inc.) were ball milled together with an equal weight (5.2 gm) of salt in 250 cc deionized (DI) water for 24 h. The salt was a 1:1 mole ratio of NaCl (Aldrich) and KCl (Aldrich) representing the eutectic composition. The mixed slurry was dried at 100° C. in an oven. The dried mass was lightly ground into powder with mortar and pestle.

### Sample 4G

4.0775 gm of bismuth oxide (Bi₂O₃, Aldrich), 0.1275 gm of aluminum oxide (Al₂O₃, Acros Organics), 0.773 gm of vanadium oxide (V₂O₅, Aldrich), and 0.1124 gm of cobalt oxide (CoO, Cerac Inc.) were ball milled together with an equal weight (5.1 gm) of salt in 250 cc deionized (DI) water for 24 h. The salt was a 1:1 mole ratio of NaCl (Aldrich) and KCl (Aldrich) representing the eutectic composition. The mixed slurry was dried at 100° C. in an oven. The dried mass was lightly ground into powder with mortar and pestle.

These dried powders were placed in closed alumina crucibles and heated in air from room temperature to 700° C. Heating rate was 10° C. per minute and held at 700° C. for 8 h. After furnace cooling, the fused mass was repeatedly washed with cold DI water. The mass was dried at 100° C. and collected as powder. X-ray powder diffraction and SEM data as summarized in table 4 showed that the samples containing 10-20 at % Co dopant replacing V (samples 4B and 4C) and 15 at % Co replacing V with 10-20 at % Al replacing Bi (samples 4E and 4F) are phase pure γ-BIMVOX powder with well developed platelets of 20-50 micron in major axis & aspect ratio 5-15. The samples with <10 at % Co dopant replacing V (sample 4A) and with no dopant at all (sample 4H) observed to be mixed phase and either mixed morphology or random equiaxed particles. The samples with 25 at % Co dopant replacing V (sample 4D) and 25 at % Al replacing Bi (sample 4G) observed to be mixed phase and either mixed morphology. M represents the corresponding dopant metal.

TABLE 4
Effect of amount of doping metal on phase and morphology

| | | Product | |
|---|---|---|---|
| Sample | Doping metal | Phase | Morphology |
| 4A | CoO; 7 at % wrt V | γ-BICOVOX + β-BICOVOX + α- | Random equiaxed particles + some platelets of |
| | | BICOVOX + BiVO₄ | 1-5 micron in major axis & aspect ratio 1-6 |
| 4B | CoO; 10 at % | γ-BICOVOX | Well developed platelets of 20-50 micron in |
| | wrt V | | major axis & aspect ratio 5-15 |
| 4C | CoO; 20 at % | γ-BICOVOX | Well developed platelets of 20-50 micron in |
| | wrt V | | major axis & aspect ratio 5-15 |
| 4D | CoO; 25 at % | γ-BICOVOX + CoO | Well developed platelets of 20-50 micron in |
| | wrt V | | major axis & aspect ratio 5-15 + Random |
| | | | equiaxed particles |
| 4E | CoO; 15 at % | γ-BICOAlVOX | Well developed platelets of 20-50 micron in |
| | wrt V + Al₂O₃ 10 | | major axis & aspect ratio 5-15 |
| | at % wrt Bi | | |
| 4F | CoO; 15 at % | γ-BICOAlVOX | Well developed platelets of 20-50 micron in |
| | wrt V + Al₂O₃; | | major axis & aspect ratio 5-15 |
| | 20 at % wrt Bi | | |
| 4G | CoO; 15 at % | γ-BICOAlVOX + Al₂O₃ | Random equiaxed particles + some platelets of |
| | wrt V + Al₂O₃; | | 2-10 micron in major axis & aspect ratio 2-6 |
| | 25 at % wrt Bi | | |
| 4H | No doping | Bi₂O₃ + V₂O₅ + CoO + γ-BICOVOX + | Random equiaxed particles |
| | | β-BICOVOX + α-BICOVOX + | |
| | | BiVO₄ | |

### Example 5

### Sample 5A

4.66 gm of bismuth oxide (Bi₂O₃, Aldrich), 0.72752 gm of vanadium oxide (V₂O₅, Aldrich), and 0.14986 gm of cobalt oxide (CoO, Cerac Inc.) were ball milled together with an equal weight (5.54 gm) of salt in 250 cc deionized (DI) water for 24 h. The salt was a 1:1 mole ratio of NaCl (Aldrich) and KCl (Aldrich) representing the eutectic composition. The mixed slurry was dried at 100° C. in an oven. The dried mass was lightly ground into powder with mortar and pestle.

### Sample 5B

4.66 gm of bismuth oxide (Bi₂O₃, Aldrich), 0.72752 gm of vanadium oxide (V₂O₅, Aldrich), and 0.14986 gm of cobalt oxide (CoO, Cerac Inc.) were ball milled together with 10% of total precursor wt. (0.55 gm) of salt in 250 cc deionized (DI) water for 24 h. The salt was a 1:1 mole ratio of NaCl (Aldrich) and KCl (Aldrich) representing the eutectic composition. The mixed slurry was dried at 100° C. in an oven. The dried mass was lightly ground into powder with mortar and pestle.

### Sample 5C

4.66 gm of bismuth oxide (Bi₂O₃, Aldrich), 0.72752 gm of vanadium oxide (V₂O₅, Aldrich), and 0.14986 gm of cobalt oxide (CoO, Cerac Inc.) were ball milled together with 1% of total precursor wt. (0.055 gm) of salt in 250 cc deionized (DI) water for 24 h. The salt was a 1:1 mole ratio of NaCl (Aldrich) and KCl (Aldrich) representing the eutectic composition. The mixed slurry was dried at 100° C. in an oven. The dried mass was lightly ground into powder with mortar and pestle.

### Sample 5D

4.66 gm of bismuth oxide (Bi₂O₃, Aldrich), 0.72752 gm of vanadium oxide (V₂O₅, Aldrich), and 0.14986 gm of cobalt oxide (CoO, Cerac Inc.) were ball milled without any salt in 250 cc deionized (DI) water for 24 h. The mixed slurry was dried at 100° C. in an oven. The dried mass was lightly ground into powder with mortar and pestle.

### Sample 5E

4.66 gm of bismuth oxide (Bi₂O₃, Aldrich), 0.72752 gm of vanadium oxide (V₂O₅, Aldrich), and 0.14986 gm of cobalt oxide (CoO, Cerac Inc.) were ball milled together with 100% of total precursor wt. (5.55 gm) of salt in 250 cc deionized (DI) water for 24 h. The salt was a 2:3 mole ratio of NaCl (Aldrich) and KCl (Aldrich). The mixed slurry was dried at 100° C. in an oven. The dried mass was lightly ground into powder with mortar and pestle.

### Sample 5F

4.66 gm of bismuth oxide (Bi₂O₃, Aldrich), 0.72752 gm of vanadium oxide (V₂O₅, Aldrich), and 0.14986 gm of cobalt oxide (CoO, Cerac Inc.) were ball milled together with 100% of total precursor wt. (5.55 gm) of salt in 250 cc deionized (DI) water for 24 h. The salt was a 3:2 mole ratio of NaCl (Aldrich) and KCl (Aldrich). The mixed slurry was dried at 100° C. in an oven. The dried mass was lightly ground into powder with mortar and pestle.

### Sample 5G

4.66 gm of bismuth oxide (Bi₂O₃, Aldrich), 0.72752 gm of vanadium oxide (V₂O₅, Aldrich), and 0.14986 gm of cobalt oxide (CoO, Cerac Inc.) were ball milled together with 100% of total precursor wt. (5.55 gm) of salt in 250 cc deionized (DI) water for 24 h. The salt was 100% NaCl (Aldrich). The mixed slurry was dried at 100° C. in an oven. The dried mass was lightly ground into powder with mortar and pestle.

### Sample 5H

4.66 gm of bismuth oxide (Bi₂O₃, Aldrich), 0.72752 gm of vanadium oxide (V₂O₅, Aldrich), and 0.14986 gm of cobalt oxide (CoO, Cerac Inc.) were ball milled together with 100% of total precursor wt. (5.55 gm) of salt in 250 cc deionized (DI) water for 24 h. The salt was 100% KCl (Aldrich). The mixed slurry was dried at 100° C. in an oven. The dried mass was lightly ground into powder with mortar and pestle.

### Sample 5I

4.66 gm of bismuth oxide (Bi₂O₃, Aldrich), 0.72752 gm of vanadium oxide (V₂O₅, Aldrich), and 0.14986 gm of cobalt oxide (CoO, Cerac Inc.) were ball milled together with 100% of total precursor wt. (5.55 gm) of salt in 250 cc deionized (DI) water for 24 h. The salt was a 3:7 mole ratio of KNO₃ (Aldrich) and KCl (Aldrich). The mixed slurry was dried at 100° C. in an oven. The dried mass was lightly ground into powder with mortar and pestle.

### Sample 5J

4.66 gm of bismuth oxide (Bi₂O₃, Aldrich), 0.72752 gm of vanadium oxide (V₂O₅, Aldrich), and 0.14986 gm of cobalt oxide (CoO, Cerac Inc.) were ball milled together with 100% of total precursor wt. (5.55 gm) of salt in 250 cc deionized (DI) water for 24 h. The salt was a 4:6 mole ratio of KNO₃ (Aldrich) and KCl (Aldrich). The mixed slurry was dried at 100° C. in an oven. The dried mass was lightly ground into powder with mortar and pestle.

These dried powders were placed in closed alumina crucibles and heated in air from room temperature to 700° C. Heating rate was 10° C. per minute and held at 700° C. for 8 h. After furnace cooling, the fused mass was repeatedly washed with cold DI water. The mass was dried at 100° C. and collected as powder. X-ray powder diffraction and SEM data as summarized in Table 5 showed that for the samples treated in salt mixture of 1:1 mole ratio of NaCl—KCl (samples 5A-5C), in salt mixture of 2:3 (sample 5E) and 3:2 (sample 5F) mole ratio of NaCl—KCl, in salt mixture of 3:7 mole ratio of KNO₃—KCl (sample 5I), and in salt mixture of 4:6 mole ratio of KNO₃—KCl (sample 5J) is phase pure γ-BICOVOX powder with well developed platelets of 20-50 micron in major axis & aspect ratio 5-15. Sample treated with no salt (sample 5D), and with only NaCl (5G) and only KCl (sample 5H) turned out to be mixed phase (γ-BICOVOX+β-BICOVOX+α-BICOVOX+BiVO₄) and with random equiaxed particles

TABLE 5
Effect of different type and different composition (wt %) of salt can affect development of the gamma
phase and platelet morphology of metal doped bismuth vanadate powder

| | Salt | | Product | |
|---|---|---|---|---|
| Sample | Type | Wt % | Phase | Morphology |
| 5A | NaCl—KCl | 100% with | γ-BICOVOX | Well developed platelets of 20-50 micron in |
| | 1:1 mole | total precursor | | major axis & aspect ratio 5-15 |
| | ratio | wt. | | |
| 5B | NaCl—KCl | 10% of total | γ-BICOVOX | Well developed platelets of 20-50 micron in |
| | 1:1 mole | precursor wt. | | major axis & aspect ratio 5-15 |
| | ratio | | | |
| 5C | NaCl—KCl | 1% with total | γ-BICOVOX | Well developed platelets of 20-50 micron in |
| | 1:1 mole | precursor wt. | | major axis & aspect ratio 5-15 |
| | ratio | | | |
| 5D | NO salt | 0% with total | Bi₂O₃ + V₂O₅ + CoO + | Random equiaxed particles |
| | | precursor wt. | γ-BICOVOX + β- | |
| | | | BICOVOX + α- | |
| | | | BICOVOX + | |
| | | | BiVO₄ | |
| 5E | NaCl—KCl | 100% with | γ-BICOVOX | Well developed platelets of 20-50 micron in |
| | 2:3 mole | total precursor | | major axis & aspect ratio 5-15 |
| | ratio | wt. | | |
| 5F | NaCl—KCl | 100% with | γ-BICOVOX | Well developed platelets of 20-50 micron in |
| | 3:2 mole | total precursor | | major axis & aspect ratio 5-15 |
| | ratio | wt. | | |
| 5G | NaCl | 100% with | Bi₂O₃ + V₂O₅ + CoO + | Random equiaxed particles |
| | | total precursor | γ-BICOVOX + β- | |
| | | wt. | BICOVOX + α- | |
| | | | BICOVOX + | |
| | | | BiVO₄ | |
| 5H | KCl | 100% with | Bi₂O₃ + V₂O₅ + CoO + | Random equiaxed particles |
| | | total precursor | γ-BICOVOX + β- | |
| | | wt. | BICOVOX + α- | |
| | | | BICOVOX + | |
| | | | BiVO₄ | |
| 5I | KCl—KNO₃ | 100% with | γ-BICOVOX | Well developed platelets of 20-50 micron in |
| | 7:3 mole | total precursor | | major axis & aspect ratio 5-15 |
| | ratio | wt. | | |
| 5J | KCl—KNO₃ | 100% with | γ-BICOVOX | Well developed platelets of 20-50 micron in |
| | 6:4 mole | total precursor | | major axis & aspect ratio 5-15 |
| | ratio | wt. | | |

### Example 6

4.66 gm of bismuth oxide (Bi₂O₃, Aldrich), 0.72752 gm of vanadium oxide (V₂O₅, Aldrich), and 0.174 gm of manganese oxide (MnO₂, Acros Organics) were ball milled together with an equal weight (5.56152 gm) of salt in 250 cc deionized (DI) water for 8 h. The salt was a 1:1 mole ratio of NaCl (Aldrich, >99%) and KCl (Aldrich, >99%), representing the eutectic composition. The mixed slurry was dried at 100° C. in an oven. The dried mass was lightly ground into powder with mortar and pestle.

### Sample 6A

Part of this dried powder was placed in a closed alumina crucible and heated in air from room temperature to 700° C. Heating rate was 0.5° C. per minute and held at 700° C. for 8 h. After heat treatment the sample was water quenched. The quenched fused mass was repeatedly washed with cold DI water for several times. The mass was dried at 100° C. and collected as powder.

### Sample 6B

Part of this dried powder was placed in a closed alumina crucible and heated in air from room temperature to 700° C. Heating rate was 10° C. per minute and held at 700° C. for 8 h. After heat treatment the sample was water quenched. The quenched fused mass was repeatedly washed with cold DI water for several times. The mass was dried at 100° C. and collected as powder.

### Sample 6C

Part of this dried powder was placed in a closed alumina crucible and heated in air from room temperature to 700° C. Heating rate was 50° C. per minute and held at 700° C. for 8 h. After heat treatment the sample was water quenched. The quenched fused mass was repeatedly washed with cold DI water for several times. The mass was dried at 100° C. and collected as powder.

### Sample 6D

Part of this dried powder was placed in a closed alumina crucible and heated in air from room temperature to 700° C. Heating rate was 10° C. per minute and held at 700° C. for 8 h. After heat treatment the sample was cooled down at a rate of 10° C. per minute. The cooled fused mass was repeatedly washed with cold DI water for several times. The mass was dried at 100° C. and collected as powder.

X-ray powder diffraction showed that all of the samples pure γ-BIMnVOX with strong (00I) orientation. A scanning electron micrograph of this sample shows particles of platelet morphology with an average size of major axis 15 to 50 micron, thickness 1 to 10 micron and aspect ratio of 5 to 15. Table 6 summarizes the results.

TABLE 6
Effect of different heating and cooling rates can affect development of the gamma phase and platelet
morphology of metal doped bismuth vanadate powder.

| | | | Product | |
|---|---|---|---|---|
| Sample | Heating Rate | Cooling Rate | Phase | Morphology |
| 6A | 0.5° C./min | Water Quenching | γ-BIMnVOX | Well developed platelets of 20-50 micron in major axis |
| | | | | & aspect ratio 5-15 |
| 6B | 10° C./min | Water Quenching | γ-BIMnVOX | Well developed platelets of 20-50 micron in major axis |
| | | | | & aspect ratio 5-15 |
| 6C | 50° C./min | Water Quenching | γ-BIMnVOX | Well developed platelets of 20-50 micron in major axis |
| | | | | & aspect ratio 5-15 |
| 6D | 10° C./min | 10° C./min | γ-BIMnVOX | Well developed platelets of 20-50 micron in major axis |
| | | | | & aspect ratio 5-15 + Random equiaxed particles |
| 6E | 10° C./min | Furnace Cooling | γ-BIMnVOX | Well developed platelets of 20-50 micron in major axis |
| | | | | & aspect ratio 5-15 |

### Example 7

4.66 gm of bismuth oxide (Bi₂O₃, Aldrich), 0.72752 gm of vanadium oxide (V₂O₅, Aldrich), and 0.174 gm of manganese oxide (MnO₂, Acros Organics) were ball milled together with an equal weight (5.56152 gm) of salt in 250 cc deionized (DI) water for 8 h. The salt was a 1:1 mole ratio of NaCl (Aldrich, >99%) and KCl (Aldrich, >99%), representing the eutectic composition. The mixed slurry was dried at 100° C. in an oven. The dried mass was lightly ground into powder with mortar and pestle.

### Sample 7A

A part of this dried powder was placed in a closed alumina crucible and heated in air at sea level of 760 psi pressure from room temperature to 700° C. Heating rate was 10° C. per minute and held at 700° C. for 8 h. After furnace cooling, the fused mass was repeatedly washed with cold DI water. The mass was dried at 100° C. and collected as powder.

### Sample 7B

A part of this dried powder was placed in a closed alumina crucible and heated in air at 660 psi pressure from room temperature to 700° C. Heating rate was 10° C. per minute and held at 700° C. for 8 h. After furnace cooling, the fused mass was repeatedly washed with cold DI water. The mass was dried at 100° C. and collected as powder.

### Sample 7C

A part of this dried powder was placed in a closed alumina crucible and heated in flowing nitrogen at sea level of 760 psi pressure from room temperature to 700° C. Heating rate was 10° C. per minute and held at 700° C. for 8 h. After furnace cooling, the fused mass was repeatedly washed with cold DI water. The mass was dried at 100° C. and collected as powder.

### Sample 7D

A part of this dried powder was placed in a closed alumina crucible and heated in flowing nitrogen at 660 psi pressure from room temperature to 700° C. Heating rate was 10° C. per minute and held at 700° C. for 8 h. After furnace cooling, the fused mass was repeatedly washed with cold DI water. The mass was dried at 100° C. and collected as powder.

### Sample 7E

A part of this dried powder was placed in a closed alumina crucible and heated in flowing argon at sea level of 760 psi pressure from room temperature to 700° C. Heating rate was 10° C. per minute and held at 700° C. for 8 h. After furnace cooling, the fused mass was repeatedly washed with cold DI water. The mass was dried at 100° C. and collected as powder.

### Sample 7F

A part of this dried powder was placed in a closed alumina crucible and heated in flowing argon at 660 psi pressure from room temperature to 700° C. Heating rate was 10° C. per minute and held at 700° C. for 8 h. After furnace cooling, the fused mass was repeatedly washed with cold DI water. The mass was dried at 100° C. and collected as powder.

### Sample 7G

A part of this dried powder was placed in a closed alumina crucible and heated in flowing argon-10% hydrogen mixture at sea level of 760 psi pressure from room temperature to 700° C. Heating rate was 10° C. per minute and held at 700° C. for 8 h. After furnace cooling, the fused mass was repeatedly washed with cold DI water. The mass was dried at 100° C. and collected as powder.

### Sample 7H

A part of this dried powder was placed in a closed alumina crucible and heated in flowing argon-10% hydrogen mixture at 660 psi pressure from room temperature to 700° C. Heating rate was 10° C. per minute and held at 700° C. for 8 h. After furnace cooling, the fused mass was repeatedly washed with cold DI water. The mass was dried at 100° C. and collected as powder.

X-ray powder diffraction and SEM data as summarized in Table 7 showed that for all the precursors products are phase pure γ-BIMnVOX powder with well developed platelets of 20-50 micron in major axis and aspect ratio 5-15.

TABLE 7
Effect of different ambient and pressure can affect development of the gamma phase and platelet
morphology of metal doped bismuth vanadate powder.

| | | | Product | |
|---|---|---|---|---|
| Sample | Environment | Pressure | Phase | Morphology |
| 7A | Air | 760 PSI | γ-BIMnVOX | Well developed platelets of 20-50 micron in major axis & |
| | | | | aspect ratio 5-15 |
| 7B | Air | 660 PSI | γ-BIMnVOX | Well developed platelets of 20-50 micron in major axis & |
| | | | | aspect ratio 5-15 |
| 7C | Flowing N2 | 760 PSI | γ-BIMnVOX | Well developed platelets of 20-50 micron in major axis & |
| | | | | aspect ratio 5-15 |
| 7D | Flowing N2 | 660 PSI | γ-BIMnVOX | Well developed platelets of 20-50 micron in major axis & |
| | | | | aspect ratio 5-15 + Random equiaxed particles |
| 7E | Flowing Ar | 760 PSI | γ-BIMnVOX | Well developed platelets of 20-50 micron in major axis & |
| | | | | aspect ratio 5-15 |
| 7F | Flowing Ar | 660 PSI | γ-BIMnVOX | Well developed platelets of 20-50 micron in major axis & |
| | | | | aspect ratio 5-15 |
| 7G | Flowing Ar-10% H2 | 760 PSI | γ-BIMnVOX | Well developed platelets of 20-50 micron in major axis & |
| | | | | aspect ratio 5-15 |
| 7H | Flowing Ar-10% H2 | 660 PSI | γ-BIMnVOX | Well developed platelets of 20-50 micron in major axis & |
| | | | | aspect ratio 5-15 |

Analysis of the intensity (a.u.) versus two-theta (°) XRD patterns of the MSS powders shows that the powder obtained at 550° C./2 h is mostly randomly oriented γ-BICOVOX (indexed to space group I4/mmm) with small amount of BiVO4 indicated by * (PDF #14-0688). Samples treated at higher temperatures for longer times were indexed to be single phase and polycrystalline γ-BICOVOX.

Up to 700° C./8 h, as treatment time and temperature increase, diffraction patterns revealed the increased (00I) orientation, an artifact of the platelet morphology and partial alignment in the sample compact. After 700° C. for 32 h treatment, intensity of the (00I) peaks clearly diminished.

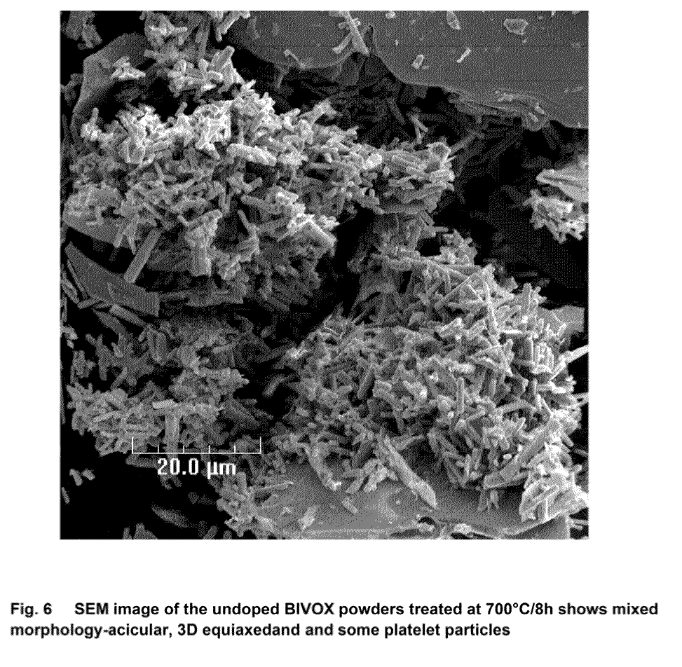

Analysis of the FESEM micrographs shows that the doped Bi₂CO_{0.15}V_{0.85}O_{11-δ} powders have platelet morphology in general. For Sample 1B (FIG. 2a) a non homogeneous microstructure with major planner dimension of 0.5-5 μm, thickness of 0.1-1 μm and aspect ratio of 1-10 was obtained. For Sample 1D (FIG. 2b), an inhomogeneous microstructure with major planner dimension of 1-10 μm, thickness of 0.5-1 μm and aspect ratio of 1-10 was obtained. As the treatment time and temperature increase the platelet particles grow in size. After 700° C./8 h of treatment (Sample 1G, FIG. 2 (d)) the average particle size was observed to increase to 20-50 μm in major plane axis and 1-10 μm in thickness. The Sample 1H (FIG. 2e) revealed the crushed and broken morphology of the platelet particles treated for longer time (32 h) at the same temperature. FIG. 4 revealed the size and aspect ratio (AR) distribution of Sample 1D and Sample 1G. Sample 1D shows the widest distribution of particle size as a percentage of the mean. Data collected from SEM images of at least 500 particles per sample were used for this statistical comparison. Analysis of the FESEM micrographs of Sample 2C revealed a very similar kind of platelet morphology for Bi₂Mn_{0.15}V_{0.85}O_{11-δ} powder, in general; FIG. 5 shows that after 700° C./8 h of treatment the average particle size was observed to increase to 20-50 μm in major plane axis and 2-10 μm in thickness. The FESEM image analysis of Sample 4H (Table 4 and FIG. 6) shows inhomogeneous and mixed morphology—acicular and platelet particles together for undoped BIVOX powders. This indicates that in order to obtain anisotropic platelet morphology partial replacement of the original element(s) from Bi4V₂O₁₁ is necessary. The Tables summarize the processing conditions and characteristics of the BIMEVOX powders.

The specification incorporates by reference the disclosure of U.S. Provisional Application Ser. No. 61/305,883 filed Feb. 18, 2010.

The present invention is, of course, in no way restricted to the specific disclosure of the specification and drawings, but also encompasses any modifications within the scope of the appended claims.

What I claim is:

1. A method comprising the steps of:
providing a bismuth precursor,
providing a vanadium precursor,
providing at least one metal dopant precursor,
mixing the bismuth precursor, the vanadium precursor and the at least one metal dopant precursor together with a salt or a salt mixture that has a eutectic melting temperature of no greater than 680° C. to form a homogeneous mixture,
heating the homogeneous mixture to a temperature of from 550° C. to 700° C. to produce a molten state of said salt or salt mixture and to obtain a metal doped bismuth vanadium oxide product that is a derivative of Bi₄V₂O₁₁, and
cooling said doped bismuth vanadium oxide product.

2. A method according to claim 1, wherein the cooled doped bismuth vanadium oxide product is in the form of a loose powder.

3. A method according to claim 1, wherein said bismuth precursor, said vanadium precursor, said at least one metal dopant precursor, and said salt or salt mixture are present in solid form.

4. A method according to claim 1, wherein water is added to said homogeneous mixture to produce a solution or suspension, and wherein said homogeneous mixture is dried prior to said heating step.

5. A method according to claim 1, wherein said salt or salt mixture is in solution, and wherein said homogeneous mixture is dried prior to said heating step.

6. A method according to claim 1, wherein said bismuth precursor is selected from the group consisting of bismuth, oxides of bismuth, chlorides of Bi, nitrates of Bi, amides of Bi, hydroxides of Bi, sulfates of Bi, sulfides of Bi, oxychlorides of Bi, acetates of Bi, and other organo-bismuth compounds and wherein said vanadium, chlorides of V, nitrates of V, amides of V, hydroxides of V, sulfates of V, sulfides of V, oxychlorides of V, acetates of V and other organo-vanadium compounds.

7. A method according to claim 6, wherein said at least one metal dopant precursor is selected from the group consisting of Zn, Cu, Co, Fe, Mn, Na, Pb, Cd, Ca, Ba, Sr, Sb, In, Al, Ti, Sn, Ru, Nb, Ta, P, rare earth elements, oxides, chlorides, nitrates, amides, hydroxides, sulfates, sulfides, oxychlorides, acetates or other water soluble salts of the preceding, and other organo-metallic compounds.

8. A method according to claim 7, wherein said at least one metal dopant precursor is present at 10 to 15 atomic % relative to vanadium and/or 10 to 20 atomic % relative to bismuth.

9. A method according to claim 1, wherein a salt mixture is used and is comprised of at least two compounds selected from the group consisting of potassium chloride, sodium chloride, and potassium nitrate.

10. A method according to claim 9, wherein said salt mixture comprises two compounds that are present at a 1:1 mole ratio.

11. A method according to claim 10, wherein said two compounds are potassium chloride and sodium chloride.

12. A method according to claim 1, wherein said method is carried out at ambient pressure, in air, flowing nitrogen, or flowing argon.

13. A method according to claim 1, wherein said salt or salt mixture comprises 1 to 50% by weight of the homogeneous mixture.

14. A method according to claim 1, wherein said heating step comprises heating said homogeneous mixture to a temperature of from 550° C. to 650° C., and holding said homogeneous mixture at that temperature for up to 32 hours.

15. A method according to claim 14, wherein the ramping rate for said heating step comprises 0.5 to 50 degrees per minute.

16. A method according to claim 1, wherein said doped bismuth vanadium oxide product is cleaned by water washing, vacuum distillation, decantation, filtering or centrifuging.

17. A metal doped bismuth vanadium oxide product that is a derivative of Bi₄V₂O₁₁ and is produced by the molten salt synthesis method of claim 1, wherein said bismuth vanadium oxide product is present in loose platelet form, and wherein such platelets are capable of being aligned such that the planes of the platelets are substantially parallel to one another.

18. A metal doped bismuth vanadium oxide product according to claim 17 selected from one of the formulas:
(Bi₂₋ₓMₓO₂)(V_{1-y}M′_{y}O_{z})
where M represents one or more dopant metals substituting for, or replacing some of, the starting Bi and having an oxidation number less than or equal to 3; M′ represents one or more dopant metals substituting for, or replacing some of, the starting V and having an oxidation number less than, equal to or greater than 5; and the values of x, y and z are the functions of the nature of the substituting elements M and M′;
(Bi₂O₂)(V_{1-y}M′_{y}O_{z})
where M′ is as explained above, and y is greater than zero;
(Bi₂₋ₓMₓO₂)(VO₂)
where M is as defined above, and x is greater than zero.
